(19) United States
(12) Patent Application Publication
(10) Pub. No.: US 2014/0102739 A1
(43) Pub. Date: Apr. 17, 2014

(54) Remote Control Tool Assembly For Use In Live Line Environments

(71) Applicant: Carl Russel Tamm, Trussville, AL (US)

(72) Inventor: Carl Russel Tamm, Trussville, AL (US)

(21) Appl. No.: 13/650,215

(22) Filed: Oct. 12, 2012

(51) Int. Cl. B25F 5/00; H02G 1/00

(52) U.S. Cl. 173/1; 173/170

(57) ABSTRACT

A remote control tool assembly for use in live line environments having an insulated pole (often termed a “hot stick”) with a tool at one end that generally includes a power supply so that the tool is fully isolatable at the end of the insulated pole. At the other end, a tool control transmitter is positioned which is configured to communicate wirelessly with the tool. Thus, the user can operate the tool remotely from the tool controller, which is particularly useful in a live line environment.

### BACKGROUND OF THE DISCLOSURE

1. Field of the Disclosure

The disclosure relates in general to a remotely operated device, and more particularly, to a remote control tool assembly. The tool assembly is well suited for operations in live line environments, where insulation of a user (i.e., lineman) is well needed. Of course, the assembly is not limited for use in such an environment, and may have utility in other environments.

2. Background Art

The need to maintain high voltage transmission and distribution equipment, apparatuses and lines is well known in the art. It is known that in many applications, the devices must be serviced and/or maintained while energized. In many instances, above certain thresholds (in some instances over 25 kV in other instances over 500 kV), it is common to utilize insulated poles (often termed a “hot stick”) to insulate a lineman from the high voltage. One such insulated pole is shown in U.S. Pat. No. 2,316,204 issued to Williams. It has been known to adapt a hand tool, such as a ratchet, to the end of such an insulated pole, either directly or through a swivel mechanism (often termed a “jack ratchet”). In prior applications, such as is shown in U.S. Pat. No. 4,326,316, issued to Dolenti, hydraulically powered tools have been provided and coupled to the end of an insulated pole.

Problematically, in each such situation, there are limitations. First, with hand tools, there are limitations as to the amount of torque or force that can be applied, and also difficulty with respect to having the strength to articulate the tools through a desired articulation. With respect to the hydraulically powered tools, there have been other problems. First, the tools themselves are quite heavy. In turn, it is difficult for a lineman to properly control the tool at the opposite end of the insulated pole. In addition, such hydraulic powered tools require a remotely positioned hydraulic power source (and thus, hydraulic lines from the power source to the hydraulic powered tool itself). For these reasons, the hydraulically powered tools have not been well received.

It is an object of the present disclosure to provide a power tool that can be utilized at the end of an insulated pole in a live line environment.

It is another object of the present disclosure to provide a power tool that is remotely actuated by a user at one end of an insulated pole with the tool at the other end of the insulated pole in a live line environment.

It is another object of the invention to provide a power tool that includes a power source coupled thereto which is remotely actuated by a user at one end of an insulated pole with the tool at the other end of the insulated pole in a live line environment.

These objects as well as other objects of the present disclosure will become apparent in light of the present specification, claims, and drawings.

### SUMMARY OF THE DISCLOSURE

The disclosure is directed to a remote control tool assembly. The remote control tool assembly utilizes an insulated pole (often termed a “hot stick”) with a tool at one end that generally includes a power supply so that the tool is fully isolatable at the end of the insulated pole. At the other end, a tool control transmitter is positioned which is configured to communicate wirelessly with the tool. Thus, the user (i.e., lineman) can operate the tool remotely from the tool controller.

More specifically, in a preferred embodiment, the remote control tool assembly comprises an insulated pole, a tool and a remote control transmitter. The insulated pole has an elongated body with a first end and a second end. A handle is positioned at the first end of the insulated pole. A tool attachment assembly is positioned at the second end of the insulated pole.

The tool is positioned at the second end of the elongated body. The tool has a body, a power source that is electrically coupled to the body, a tool working portion extending from the body and an attachment member configured for attachment to the tool attachment assembly of the insulated pole. The tool working portion comprising the portion of the tool that is configured to act upon an outside member or element (i.e., a bolt, a wire, a cable, a tree branch, etc.). The tool further includes a tool control receiver that is configured to control the tool working portion. The tool control receiver is configured to receive signals and translate those signals into the proper output to control the tool (i.e., rotation control of a drill bit, a socket, blade, etc.).

The remote control transmitter is positioned proximate the second end of the insulated pole. The remote control transmitter has control circuitry configured to communicate wirelessly with the tool control receiver and an actuator in electrical communication with the control circuitry. Upon actuation by a user, the actuator provides instructions through the remote control transmitter to the tool control receiver, to, in turn, control the tool working portion.

In a preferred embodiment, the insulated pole comprises a fiberglass rod having a substantially circular geometry.

In another preferred embodiment, the handle of the insulated pole comprises a resilient polymer material.

In another preferred embodiment, the tool comprises at least one of an impact tool, a drill, a reciprocating saw, a grinder, a chainsaw, a cable cutting tool and a compression tool.

In yet another preferred embodiment, the tool is removably coupled to the second end of the insulated pole.

Preferably, the tool is pivotably coupled to the insulated pole.

In yet another preferred embodiment, the attachment assembly of the insulated pole further comprises a flange extending outwardly from the second end of the elongated body in a direction generally parallel to the elongated body. An opening extends through the flange which is substantially perpendicular to the elongated body. The attachment member further includes a corresponding flange having a corresponding opening. A fastener is extended through the opening of the tool attachment assembly and the opening of the attachment member coupling the tool to the insulated pole. It will be understood that such a configuration allows for pivotable movement of the tool relative to the insulated pole about an axis defined by the fastener.

In some such preferred embodiments, the fastener includes one of a bolt and a quick release mechanism.

In another preferred embodiment, the power source comprises a battery pack removably coupled to the tool body.

In another preferred embodiment, the tool control transmitter is releasably coupled to the first end of the elongated body of the insulated pole.

In yet another preferred embodiment, the tool control assembly further comprises a tool control transmitter body and a mount assembly comprising a clamp and at least one fastener. The elongated body of the insulated pole is sandwiched between the tool control transmitter body and the clamp. The at least one fastener extends between the tool control transmitter body and the clamp thereby coupling the tool control transmitter body and the clamp together.

In a preferred embodiment, the actuator comprises at least one of a trigger, a switch, and a toggle.

In another preferred embodiment, the tool control transmitter includes a plurality of actuators.

Preferably, the tool control receiver and the tool control transmitter communicate through one of the group consisting of: RF, IR, WiFi, Bluetooth, Zigbee, and personal network bands such as those of IEEE Standard 802.15.4.

In another aspect of the disclosure, the disclosure comprises a method of remotely operating a tool in a live line environment comprising the steps of: providing a tool having a power supply and a tool control receiver coupled thereto; coupling the tool and the power supply to a second end of an insulated pole, the insulated pole having an elongated body; coupling a tool control transmitter to a first end of an insulated pole, the tool control transmitter having control circuitry and at least one actuator electrically coupled thereto; placing the tool control transmitter and the tool control receiver in wireless communication; positioning the tool in a desired working orientation; and actuating the at least one actuator to, in turn, control the tool.

In a preferred embodiment, the tool comprises an impact driver, the step of positioning further comprising the steps of positioning the impact driver to engage a bolt. Additionally, the step of actuating further comprising the step of actuating the at least one actuator to rotate the bolt in one of a clockwise and counterclockwise manner. Of course, and as will be explained below, other tools are contemplated, and the disclosure is not limited to any particular type of tool or any particular application.

In another preferred embodiment, the step of coupling a tool control transmitter comprises the step of releasably coupling the tool control transmitter to the first end of the insulated pole.

### BRIEF DESCRIPTION OF THE DRAWINGS

The disclosure will now be described with reference to the drawings wherein:

FIG. 1 of the drawings is a perspective view of the remote control tool assembly of the present disclosure, which is well suited for use in live line environments;

FIG. 2 of the drawings is a side elevational view of the remote control tool assembly of the present disclosure;

FIG. 3 of the drawings is a partial perspective view of the remote control tool assembly of the present disclosure, showing, in particular, the tool along with the tool attachment assembly of the insulated pole and the tool attachment member of the tool;

FIG. 4 of the drawings is a partial perspective view of the remote control tool assembly of the present disclosure, showing, in particular, the tool along with the tool attachment assembly of the insulated pole and the tool attachment member of the tool;

FIG. 5 of the drawings is a partial perspective view of the remote control tool assembly of the present disclosure, showing, in particular, the first end of the body of the insulated pole having the tool control transmitter coupled thereto;

FIG. 6 of the drawings is a partial perspective view of the remote control tool assembly of the present disclosure, showing, in particular, the first end of the body of the insulated pole having the tool control transmitter coupled thereto;

FIG. 7 of the drawings is a partial side elevational view of the remote control tool assembly of the present disclosure, showing, in particular, the first end of the body of the insulated pole having the tool control transmitter coupled thereto; and

FIG. 8 of the drawings is a partial side elevational view of the remote control tool assembly of the present disclosure, showing, in particular, the first end of the body of the insulated pole having the tool control transmitter coupled thereto.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

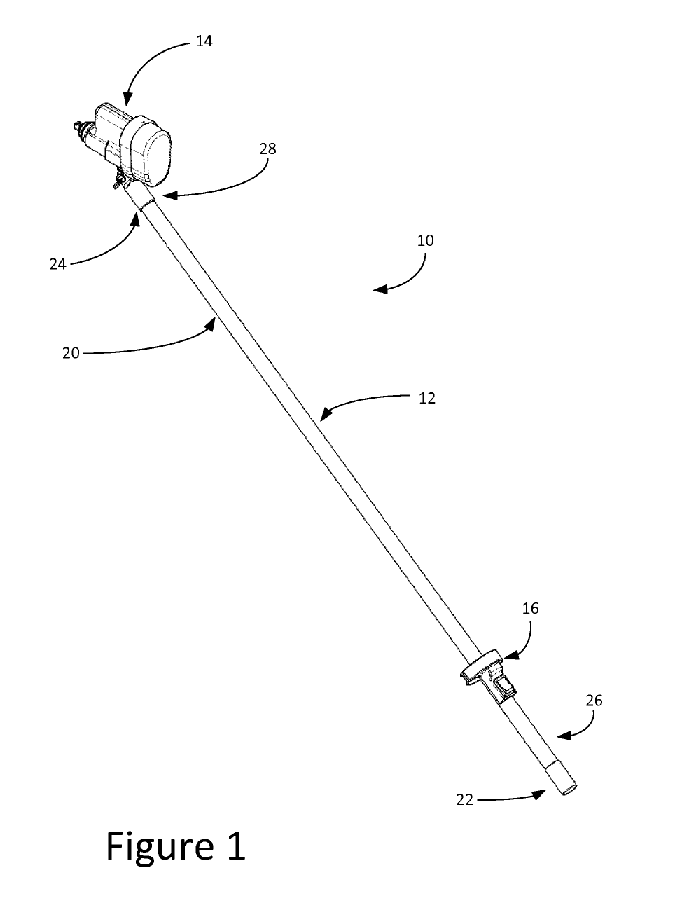

Referring now to the drawings and in particular to FIG. 1, remote control tool assembly for live line environments is shown as 10. It will be understood that such a tool has utility in a live line environment by providing a powered tool at one end that is fully electrically isolated from the other end of the tool, but controllable from the other end of the tool. As will be explained, among other tools, an impact tool, drills, reciprocating saws, grinders, chainsaws, cable cutting tools, compression tools, among others can be utilized at the first end, and controlled from the second end of the tool, in a completely isolated configuration.

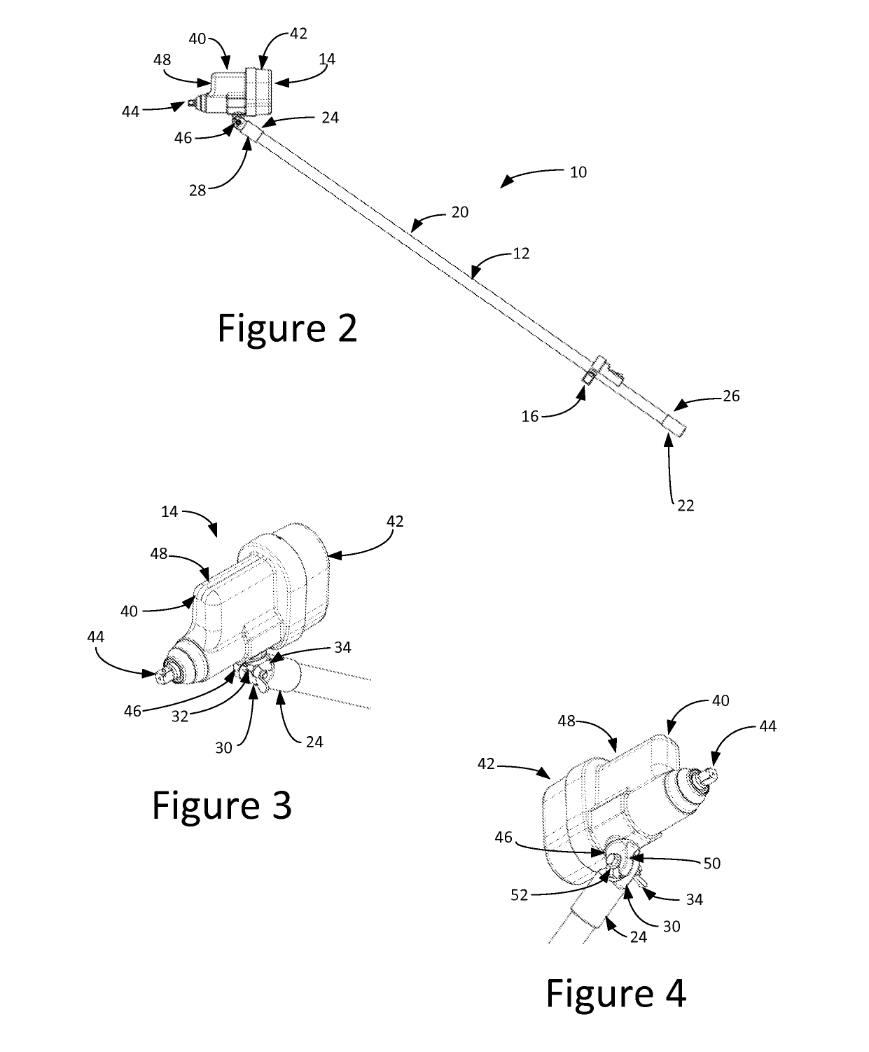

The remote control tool assembly 10 is shown in FIGS. 1 and 2 as comprising insulated pole 12, tool 14 and tool control transmitter 16. The insulated pole 12, commonly referred to as a “hot stick”, includes elongated body 20 having a first end 26 and a second end 28 opposite the first end 26. A handle 22 is provided at the first end 26 of the elongated body 20. A tool attachment assembly 24 is coupled to the second end 28 of the elongated body. The elongated body 20 of the insulated pole 12 comprises an insulative material, such as a fiberglass or the like, and is typically substantially uniform and substantially circular in cross-sectional configuration. Of course, other insulative materials are also contemplated for use, including, but not limited to polymers, organic materials and the like, as are different cross-sectional configurations and variations thereto along the length thereof. Generally, the elongated body may comprise a single monolithic member which is between two and ten feet in length. In other configurations, longer or shorter members are likewise contemplated. For longer members, the elongated body may comprise a plurality of elements that can be coupled together (i.e., end to end, or telescopic). It will be understood that the length of the insulated pole is often dictated by the voltage of the line upon which the user/lineman is operating. For example, up to 15 kV, a minimum phase to ground distance of two feet, one inch must be maintained. Between 161 kV and 169 kV a minimum phase to ground distance of four feet must be maintained. At 500 kV, a minimum phase to ground distance of eleven feet, three inches must be maintained. It is known to one of skill in the art that such distances have been established and are known in the art.

The handle 22 shown at first end 26 may comprise any number of different configurations. In one embodiment, the handle 22 may comprise a rubber or other natural or synthetic resilient member which aids in the retention of the insulated pole by the user. Generally, such a handle 22 will include a grip retaining surface configuration, such that the material and the surface configuration aids in the gripping thereof by a user, even in inclement weather.

With reference to FIGS. 3 and 4, the tool attachment assembly 24 is shown at second end 28 as comprising flange 30 having opening 32 and fastener 34. The flange 30 extends outward from the second end 28, with the opening 32 extending therethrough, substantially perpendicular to the flange 30. As will be explained, the flange 30 corresponds to a mounting assembly flange 50 of the tool 14, with the fastener 34 extending between both of the flanges coupling the two together, wherein a certain amount of pivoting is permitted relative to the flanges. The fastener may include a commonly utilized bolt and nut, or may comprise a quick connect type of connector that allows for easy loosening/tightening and quick adjustment. Of course, other fasteners are likewise contemplated, such as, for example, pins, industrial Velcro, magnetic closures, among others.

Of course, other configurations of the attachment assembly are contemplated. For example, a locking ball and socket can be utilized to permit pivoting and rotation in multiple planes and dimensions, thus, allowing multiple degrees of freedom of relative movement. In other embodiments, the tool and the insulated pole may be coupled to each other in a fixed orientation, wherein the two are not movable relative to each other when coupled together. In still other embodiments, the tool and the insulated pole may be coupled together in a remotely movable configuration.

The tool 14 is shown in FIGS. 3 and 4 as comprising body 40, power source 42, tool work end 44 and attachment member 46. Body 40 generally includes any mechanical portions of the tool (such as, for example, a motor, gears, transmission, control circuitry, among others). Among other items, the control circuitry includes receiver 48 which is configured to receive signals from the tool control transmitter 16. The particular manner in which the receiver communicates with the tool control transmitter will be described below. It will be understood that the receiver 48 is energized by the power source 42 and is electrically coupled to the motor, for example, which is mechanically coupled to the tool work end 44.

Power source 42 comprises a self-contained battery pack (for example, an 18V lithium ion battery pack). Of course, other battery technologies are contemplated, such as alkaline, Ni-CAD, NIMH, LIPolymer, among others). Preferably, the power source 42 is releasably coupled to the tool in a single unit. In such an assembly, multiple power sources can be carried, and replaced if the charge is depleted.

Additionally, other power sources, generally that are self-contained are likewise contemplated for use. These could include solar cells (generally coupled to control circuitry and battery cells), fuel cells, and the like. It is preferred that the power source 42 be coupled to the elongated body at the second end of the insulated pole 12. In other embodiments, it is contemplated that the power source is separated from the tool and coupled thereto through cables and the like. In such an instance, the power source is nevertheless positioned at the second end 28 of the elongated body with a substantial portion of the insulated pole extending between the power source and the first end 26 of the elongated body 20.

The tool working end 44 generally comprises the moving portion of the tool that moves relative to the tool. This may include rotating portions, translating portions, pivoting portions, among others. It is contemplated that any number of different tools may be utilized. With reference to FIG. 1, an impact tool is shown. Such a tool generally has a rotating tip which has a ratchet drive (i.e., typically ½″ drive or ¾″ drive) configured to receive sockets and the like. Of course, other configurations are likewise contemplated, such as smaller ratchet drives, or larger industry specific ratchet drives.

Of course, other tools are likewise contemplated. For example, the tool may comprise a drill with a chuck positioned at the working end which is configured to releasably retain a drill bit or the like. The tool may also comprise another piece of equipment which has a rotating bit, such as a scroll saw, or a cutoff wheel or grinder, a cable cutting tool, among others. In other embodiments, the tool may comprise a vibrating tool, such as a multi-tool or the like, wherein the blade working portion comprises a bit (such as a saw or blade) that vibrates through small oscillations back and forth along a plane that is generally perpendicular to the tool axis. In yet other embodiments, the tool may comprise a saw wherein the blade or saw oscillations are generally along the axis of the tool. In still other embodiments, the tool may comprise a chainsaw. In still other embodiments, the tool may comprise a compression tool. The particular configuration of the tool, and the particular tool contemplated is not limited by the present disclosure, and, generally such tools (but not the manner described in this disclosure) are known for use at or near live line environments, that is, either on the lines directly, or on other objects proximate a line (i.e., tree branches and the like).

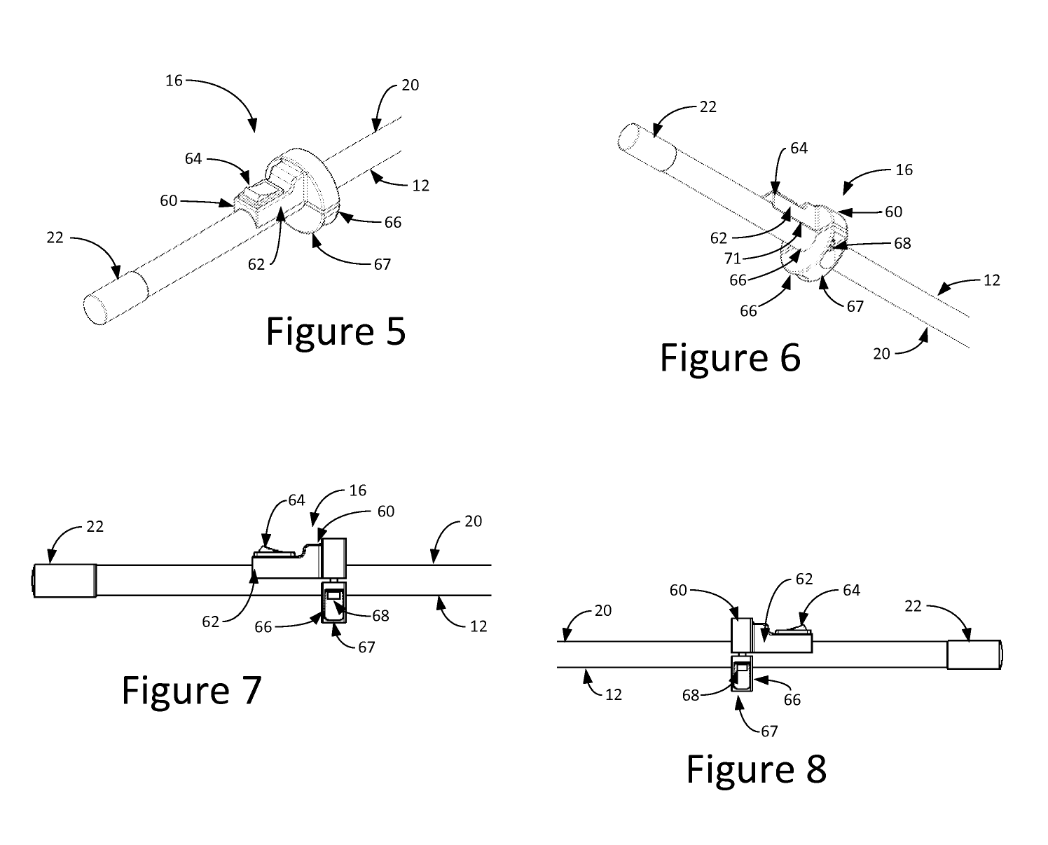

The tool control transmitter 16 is shown in FIGS. 5 through 8 as comprising body 60, control circuitry 62, actuator 64 and mounting assembly 66. The tool control transmitter 16, as will be explained, is positioned proximate the first end 26 of the elongated body of the insulated pole, spaced apart from the tool 14, and electrically isolated therefrom. The body 60 typically comprises a housing defining a cavity. Typically, the body 60 comprises an injection molded polymer component, although others are contemplated. The control circuitry 62 includes a means by which to communicate with the tool control receiver 48 of the tool 14. To maintain the electrical isolation, the communication can be achieved through any number of different wireless means, including, but not limited to RF, IR, WiFi, Bluetooth, Zigbee, personal network bands such as those of IEEE Standard 802.15.4, among others. It will be understood that the distance between the tool control receiver 48 and the tool 14 is relatively short, and, as such, any number of the protocols (many of which can be implemented quite easily and in a cost effective manner) can be utilized.

The actuator 64 may comprise a plurality of switches, toggles, buttons and the like which are configured to direct the tool control transmitter to transmit a signal to the tool control receiver so that the tool undertakes a certain action. For example, in the case of an impact driver, a first button can be provided which directs the tool control transmitter to send a signal to the tool control receiver to rotate in a first direction. A second button can be provided which imparts a similar action in the opposite direction. Other embodiments may include different buttons, toggles, switches, triggers, and the like to achieve the necessary control over the tool 14. For example, with a chainsaw, a trigger may be employed which can send signals to the tool corresponding to variability of the force applied to the device.

The mounting assembly 66 comprises a clamp member 67 and a plurality of fasteners 68. It will be understood that the body 60 includes a lower, insulated pole mounting surface 71. Thus, preferably the insulated pole mounting surface 71 shape matingly corresponds to the arcuate configuration of the insulated pole, so as to provide a mating configuration for purposes of coupling thereto. Similarly, the clamp member 67 includes a surface 72 which shape matingly engages with the elongated body of the insulated pole opposite of the portion to which the pole mounting surface 71 is mounted upon. Thus, when combined, the insulated pole mounting surface 71, the two components extend around the insulated pole and sandwich the insulated pole therebetween. The fasteners 68 are configured to couple the elongated body and the clamp 67 to each other, to maintain the releasable engagement. In other embodiments, the clamp may comprise a quick release mechanism, or other mechanism that can releasably retain the tool control transmitter 16 to the body of the insulated pole.

The tool control transmitter 16 is positioned along the insulated pole 12 at a strategic position therealong. For example, for a 230 kV line, there must be at least 5′3″ of distance of the insulated pole between the second end and the first end thereof. In such an instance, the control transmitter 16 can be positioned outside of this limit, and, thus, can form a stop for the user's hands, thereby limiting the user from extending his or her hand beyond the control transmitter (and thus, keep the user beyond the 5′3″ minimum).

It will be understood that the tool control transmitter may be integrally coupled to the insulated pole, wherein the insulated pole and the transmitter are provided as an integrated unit. In other embodiments, the tool control transmitter may be permanently coupled thereto. In many embodiments, a quick release or other releasable retention is contemplated. This is advantageous because it allows for a first user to use both arms to retain the insulated pole, while an associate utilizes the tool control transmitter to provide instructions to the tool and to control the same.

In operation, the user first selects the tool 14 that will be utilized. For example, an electric impact wrench can be selected. The user then assembles the tool so that it is complete. First, the user insures that an adequate power source 42 is provided and coupled to the tool body. Generally, the power source 42 comprises a battery pack, such as an 18V Lithium Ion battery pack. Once coupled, the user can then select an impact socket for use and attachment to the tool working end by coupling the impact socket to the socket drive thereat.

At the same time, the insulated pole is selected. Among other determinations, the particular use and the location where the use will take place are among a number of different considerations when selecting the insulated pole. Once both the tool and the insulated pole are selected, the two must be coupled together. To achieve the same, the flange 30 of the tool attachment assembly 24 of the insulated pole 12 and the flange 50 of the attachment member 46 of the tool 14 are coupled together. In particular, the two are positioned in an overlying configuration so that the openings 32, 52 line up with each other. Finally, fastener 34 is extended therethrough and tightened. As the fasteners are tightened, the tool can be pivoted relative to the insulated pole so that the two are angularly disposed relative to each other in the desired configuration. Fully tightened, the two are locked to each other and are precluded from relative movement.

The tool control transmitter 16 is also coupled to the insulated pole. It will be understood that the tool control transmitter can be coupled at any point after the selection of the tool and the insulated pole. In the embodiment shown, the tool body 60 is positioned along the insulated pole in the proper position. In such a position, the pole mounting surface abuts the insulated pole. Once positioned, the clamp 67 is then positioned in the desired orientation. Finally, when the two are positioned in a final orientation, the fasteners 68 clamp the two structures together. The fasteners are tightened and the tool control transmitter 16 is in the proper desired operational configuration.

To utilize the tool, the user, often referred to as a lineman, is first positioned in the proper location. In the embodiment shown, the lineman could utilize the assembly to tighten a bolt or the like. Often times, the lineman is positioned through the use of a bucket truck (often referred to as a cherry picker), on an aerial work platform or other structure. It will be understood that when working on high-voltage electrical power lines, until it is known with certainty as being otherwise, the lineman must assume that the line is live and, that the line is energized.

Once positioned in the proper location, the lineman can position the tool in a working orientation (i.e., the impact socket can be coupled to a bolt or the like). Once coupled, the lineman can utilize the tool control transmitter to control the tool. In the embodiment shown, the tool control transmitter has an actuator which comprises a plurality of switches. The switches provide different control instructions to the tool, such as rotation direction, rotation speed, etc. Thus, the lineman can control the tool that is remotely positioned.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A remote control tool assembly comprising:
an insulated pole having an elongated body with a first end and a second end spaced apart from the first end, a handle positioned at the first end of the insulated pole and a tool attachment assembly positioned at the second end of the insulated pole;
a tool positioned at the second end of the elongated body, the tool having a body, a power source electrically coupled to the body, a tool working portion extending from the body and coupled to the power source, and an attachment member configured for attachment to the tool attachment assembly of the insulated pole, the tool further including a tool control receiver configured to control the tool working portion; and
a remote control transmitter positioned proximate the second end of the insulated pole, the remote control transmitter having control circuitry configured to communicate wirelessly with the tool control receiver and at least one actuator in electrical communication with the control circuitry, wherein a user upon actuation of the at least one actuator provides instructions through the remote control transmitter to the tool control receiver, to, in turn, control the tool working portion.

2. The remote control tool assembly of claim 1 wherein the insulated pole comprises a fiberglass rod having a substantially circular geometry.

3. The remote control tool assembly of claim 1 wherein the handle of the insulated pole comprises a resilient polymer material.

4. The remote control tool assembly of claim 1 wherein the tool comprises at least one of an impact tool, a drill, a reciprocating saw, a grinder, a cable cutting tool, a chainsaw, and a compression tool.

5. The remote control tool assembly of claim 1 wherein the tool is removably coupled to the second end of the insulated pole.

6. The remote control tool assembly of claim 1 wherein the tool is pivotably coupled to the insulated pole.

7. The remote control tool assembly of claim 6 wherein the attachment assembly of the insulated pole further comprises a flange extending outwardly from the second end of the elongated body in a direction generally parallel to the elongated body with an opening extending therethrough which is substantially perpendicular to the elongated body, and the attachment member further includes a corresponding flange having a corresponding opening, whereupon a fastener is extended through the opening of the tool attachment assembly and the attachment member coupling the tool to the insulated pole, while facilitating pivotable movement of the tool relative to the insulated pole about an axis defined by the fastener.

8. The remote control tool assembly of claim 7 wherein the fastener includes one of a bolt and a quick release mechanism.

9. The remote control tool assembly of claim 1 wherein the power source comprises a battery pack removably coupled to the tool body.

10. The remote control assembly of claim 1 wherein the tool control transmitter is releasably coupled to the first end of the elongated body of the insulated pole.

11. The remote control assembly of claim 10 wherein the tool control assembly further comprises a tool control transmitter body and a mount assembly comprising a clamp and at least one fastener, wherein the elongated body of the insulated pole is sandwiched between the tool control transmitter body and the clamp, with the at least one fastener extending between the tool control transmitter body and the clamp thereby coupling the tool control transmitter body and the clamp together.

12. The remote control assembly of claim 1 wherein the actuator comprises at least one of a trigger, a switch, and a toggle.

13. The remote control assembly of claim 1 wherein the tool control transmitter includes a plurality of actuators.

14. The remote control assembly of claim 1 wherein the tool control receiver and the tool control transmitter communicate through one of the group consisting of: RF, IR, WiFi, Bluetooth, Zigbee, and personal network bands such as those of IEEE Standard 802.15.4.

15. A method of remotely operating a tool in a live line environment comprising the steps of:
providing a tool having a power supply and a tool control receiver coupled thereto;
coupling the tool and the power supply to a second end of an insulated pole, the insulated pole having an elongated body;
coupling a tool control transmitter to a first end of an insulated pole, the tool control transmitter having control circuitry and at least one actuator electrically coupled thereto;
placing the tool control transmitter and the tool control receiver in wireless communication;
positioning the tool in a desired working orientation in a live line environment;
actuating the at least one actuator to, in turn, control the tool.

16. The method according to claim 15 wherein the tool comprises an impact driver, the step of positioning further comprising the steps of:
positioning the impact driver to engage a bolt;
and the step of actuating further comprising the step of:
actuating the at least one actuator to rotate the bolt in one of a clockwise and counterclockwise manner.

17. The method according to claim 15 wherein the step of coupling a tool control transmitter comprises the step of releasably coupling the tool control transmitter to the first end of the insulated pole.
